(19) United States
(12) Patent Application Publication
(10) Pub. No.: US 2026/0264291 A1
(43) Pub. Date: Sep. 10, 2026

(54) A REACTIVE EXTRUSION LINE AND METHOD FOR MANUFACTURING THERMOPLASTICS FROM CELLULOSE

(71) Applicant: TALLINN UNIVERSITY OF TECHNOLOGY, Tallinn (EE)

(72) Inventors: Andres KRUMME, Tallinn (EE); Viktoria GUDKOVA, Tallinn (EE); Elvira TARASOVA, Tallinn (EE); Illia KRASNOU, Tallinn (EE)

(21) Appl. No.: 19/167,153

(22) PCT Filed: Mar. 20, 2024
(86) PCT No.: PCT/IB2024/052691

§ 371 Date: Sep. 19, 2025

(30) Foreign Application Priority Data
Mar. 20, 2023 (EE) P202300008

(51) Int. Cl. B29B 9/06; B29B 7/74; B29B 9/16; B29K 1/00

(52) U.S. Cl. CPC B29B 9/065; B29B 7/7485; B29B 9/16; B29B 2009/168; B29K 2001/00

(57) ABSTRACT

A reactive extrusion line for manufacturing thermoplastics from cellulose, comprising a premixing tank, a compounder, an underwater pelletizer, a solid separation unit, a washing unit and drying unit. A method for manufacturing thermoplastic material from cellulose in a continuous process, comprising mechanically pre-mixing a cellulose and an ionic liquid as a solvent, treating the mixture in a compounder, forming flakes in an underwater pelletizer, separating flakes from water and solvent, washing the flakes; and drying said flakes into a solid cellulose derivative.

### FIELD OF TECHNOLOGY

The invention relates to devices and methods for manufacturing thermoplastics from cellulosic materials, and particularly, such devices and methods involving treating such cellulosic materials in an extruder.

### BACKGROUND ART

Raw cellulose is a challenging material for processing in plastics industry: the material is not thermoplastic in its natural state. This issue is solved by acylation of the cellulose macromolecules and turning some or nearly all hydroxyl groups into ester groups. Such derivatives lose hydrogen bonding between macromolecules and become thermoplastic. Cellulose esters with longer aliphatic moieties other than acetic (C2), ranging in size from C3 to C18 such as cellulose fatty acid esters exhibit plasticized polymer behaviour. Regarding sustainability, the origin of the acylation agent, the efficiency/controllability of the acylation, and the composition of by-products must be considered. A prospective route is replacing synthetic agents with bio-based ones such as plant oils.

Dissolution of cellulose limits mass production of the thermoplastic cellulose derivatives. Recently, ionic liquids (IL) have been found to be good, sustainable solvents for cellulose. ILs are highly polar and therefore can break the hydrogen bonds between macromolecules of cellulose. In addition, ILs are not volatile, they can be easily recycled and are considered nontoxic in most cases. Protonic IL superbases are the most novel and promising solvents for cellulose dissolution due for several reasons. They can dissolve cellulose at high concentrations, have low moisture sensitivity, low toxicity, and can be recycled repeatedly without degradation. Additionally, they behave as ionic compounds with low vapour pressure at acylation temperatures of cellulose but can be dissociated to superbase and acid at higher temperatures. This allows purification of the components by distillation.

The modification method should lead to the highest yield with the shortest time, minimum usage of energy, solvents, and acylation agents, while producing the desired degree and pattern of substitution. The classical approach is batch-wise acylation in a stirred reactor or kneader. The increase in cellulose concentration in the acylation environment leads to increased viscosity, which limits the reactor-based methods.

Known are the following:

1. Sustainable Transesterification of Cellulose with High Oleic Sunflower Oil in a DBU-CO2 Switchable Solvent. ACS Sustainable Chem. Eng. 2018, 6, 8826-8835. DOI: 10.1021/acssuschemeng.8b01186

Cellulose was stirred in Dimethyl sulfoxide (DMSO) followed by addition of Diazabicycloundecene (DBU). The cloudy suspension was transferred to a steel pressure reactor, where 5 bar of CO₂ was applied at 30° C. for 15 min, after which the obtained clear cellulose solution was transferred to a round-bottom flask. High oleic sunflower oil was added and stirred vigorously, and the reaction was performed at 115° C. from 6 to 24 h depending on the experiment. The obtained hot homogeneous mixture was added dropwise into isopropanol. The obtained precipitate was filtered and washed twice with isopropanol. After filtration, the precipitate was solubilized in THF and reprecipitated in distilled water to remove any remaining DBU and DMSO. The final precipitate obtained after filtration was dried under vacuum at 60° C. for 24 h leading to a white fibrous material as the final product.

The problem with this method is long processing time (6-24 h) and high energy consumption. Also, cellulose concentration is low (5 wt-% in solution) since only low viscosity cellulose solutions can be processed in the reactor and viscosity is increasing with increase in cellulose concentration in the solution.

2. Carboxymethylation of Cellulose Using Reactive Extrusion. Carbohydrate Polymers 87 (2012) 2246-2254. doi: 10.1016/j.carbpol.2011.10.056

Cotton linter pulp sheets were cut into pieces and shredded to a fluff using a blender. NaOH solution in aqueous ethanol or distilled water was added to the cellulose fluff under a nitrogen atmosphere and then shredded in the blender for 5 min. For high ethanol concentrations, NaOH was not completely soluble and the suspension was used as is. Powdered sodium mono chloro acetate (SMCA) was then added to the alkali cellulose and the formulation was again shredded in the blender, under a nitrogen atmosphere. The formulation was then mixed in a planetary mixer and sealed in plastic bags, with nitrogen maintaining an inert atmosphere, and stored at 25° C. for 7 h, for mercerization. A co-rotating twin-screw extruder with four heating zones and an injection port in the barrel, was used as a reactor for carboxymethylation of cellulose. The extruder was operated without a nozzle and die because of the fibrous and non-thermoplastic nature of cellulose. The formulation was force fed into the second zone of the extruder screw using a plastic plunger. Nitrogen was injected in the extruder barrel through the injection port. The barrel temperature for the feed zone was set at 100° C. and the temperatures for both the subsequent zones were set at 150° C. The extrudates were sealed in the plastic bags and stored under inert conditions until further processing. The extrudates were ground for purification using a blender and separated from the by-products by centrifuging an 80% aqueous ethanol suspensions using a centrifuge at 4000 rpm. The aqueous ethanol was periodically replaced. The pHs of the extrudates were neutralized by adding glacial acetic acid to the ethanol. The extrudates were centrifuged until the NaCl content was found to have been reduced below 0.1 wt %. Finally, the extrudates were washed with anhydrous ethanol and dried overnight in a vacuum oven.

The problem with this reactive extrusion (REX) method is that it leads to water soluble derivatives of cellulose that are not thermoplastic. The process is conducted as heterogeneous, without full dissolution of cellulose, which leads only partial surface functionalisation of cellulose.

3. Chemical Modification of Cellulose by In Situ Reactive Extrusion Inionic Liquid. Carbohydrate Polymers 99 (2014) 126-131. http://dx.doi.org/10.1016/j.carbpol.2013.07.084

Cellulose powder was dried under vacuum at 70° C. for 24 h. With 1-Butyl-3-methylimidazolium chloride (BMIMCI) as reaction medium, cellulose was mixed with urea, phthalic anhydride (PA), maleic anhydride (MA) and butyl glycidyl ether (BGE) using a blender for several seconds, respectively. Four cellulose/BMIMCI/modifier mixtures were extruded at a constant ratio (20 wt %/60 wt %/20 wt %). The extrusion process experiments were implemented on a co-rotating twin-screw extruder (L/D=48, D=35 mm). The barrel temperatures of the extruder for these mixtures except cellulose/BMIMCI/BGE from zone 1 to zone 9 were 100, 110, 120, 130, 140, 140, 150, 150 and 150° C. The die temperature was 140° C. The screw rotation speed was 50 rpm and the retention time during extrusion was 10 min. Besides, the mixture of cellulose/BMIMCI (25 wt %/75 wt %) was also extruded at the same condition. Due to the low boiling point of BGE, the barrel temperatures of the extruder for cellulose/BMIMCI/BGE from zone 1 to zone 9 were set to 80, 80, 90, 100, 110, 110, 120, 120 and 120° C., and the die temperature was 110° C. After reactive extrusion, modified cellulose were washed with distilled water and alcohol successively and then extracted with acetone for 24 h to remove BMIMCI and unreacted modifier. Finally, the modified cellulose were washed with distilled water again and dried at 60° C. for 24 h in a vacuum oven, which were named as cellulose-g-urea, cellulose-g-PA, cellulose-g-MA, cellulose-g-BGE and regenerated cellulose, respectively.

The problem with this REX based homogeneous acylation of cellulose using the first generation ionic liquids with limited recycling capacities. Non-biobased acylation agents are used and their chain length can not provide intrinsic plasticisation of the product.

4. Continuous Cellulose Pre-Treatment and BO-Mass Processing by Reactive Extrusion. U.S. Pat. No. 9,161,556 B2

Cellulosic materials are treated with Supercritical Carbon Dioxide in an extruder. Machine configuration and operating parameters are strictly controlled in a manner to enhance the ability of Supercritical CO₂ to enter into the cells. This results in a controlled deterioration of the cell walls, increasing the reactivity of cellulose and also enhancing the rate and the extent of cellulose hydrolysis. This precisely controlled combination of pressure, shear & temperature accelerates the penetration of carbon dioxide molecules into the crystalline structures, thus more glucose is produced from cellulosic materials after the cell is destructurized as compared to those without the pretreatment increasing glucose yield by as much as 50%. Concurrent saccharification and fermentation tests also show the increase in the available carbon source from the cellulosic materials for fermentation to produce ethanol. As the system operates at low temperature, it will not cause degradation of Sugars Such as those treated with the high temperatures involved in many systems discussed.

The problem with this REX based method for pre-treatment, swelling of cellulose for facilitating further fermentization or breaking down to sugars and cannot be used for making thermoplastics.

5. Low Waste Process of Rapid Cellulose Transesterification Using Ionic Liquid/DMSO Mixed Solvent: Towards More Sustainable Reaction Systems. Carbohydrate Polymers 256 (2021) 117560. https://doi.org/10.1016/j.carbpol.2020.117560

Cellulose esterification with vinyl laurate was performed in a micro compounder Xplore MC5 (DSM Xplore, Netherlands) equipped with a co-rotating twin screw and a barrel volume of 5 cm³. Prior to REX process, MCC was dried at 70° C. for at least 12 h in a vacuum oven. The MCC-plasticizer mixture was obtained by thoroughly mixing 0.64 g (3.95 mmol) of MCC (dry basis) with 2.56 g of EmimOAc/DMSO mixture (1/3, g/g) in a beaker. After that, 2.68 g (11.85 mmol) of reagent vinyl laurate was added to the MCC-plasticizer mixture. The resulting composition was introduced gradually into the hopper of the Xplore MC5 reactor preheated to the selected temperature (120° C.) and ran at 60 rpm. The residence time in synthesis was adjusted to 10 min by using the recirculation channel. The extruded product was firstly dispersed in a 200 mL of methanol followed by centrifugation. After an initial centrifugation the supernatant containing VL and EmimOAc/DMSO was separated from the precipitate which contained the desired cellulose ester. The cellulose laurate precipitate was washed with an excess of methanol, air-dried at room temperature and dried in the vacuum oven at 70° C. for 24 h.

This method is a REX based homogeneous acylation of cellulose using the first generation IL-s with limited recycling capacities. Non-biobased acylation agent is used limiting sustainability of the process.

6. Method for the Production of Substituted Polysaccharides Via Reactive Extrusion, U.S. Pat. No. 9,637,560B2

A process for the acetylation of a polysaccharide via reactive extrusion to form a polysaccharide acetate was disclosed, comprising forming an extrusion mixture comprising the polysaccharide, acetic anhydride, and iodine, wherein the polysaccharide is selected from the group consisting of a starch and a cellulose, and wherein the extrusion mixture has a weight ratio of acetic anhydride to polysaccharide that in the range of about 0.5 to about 8, and wherein the iodine is at an amount such that is in the range of about 0.04 to about 5% by weight of the acetic anhydride; feeding the extrusion mixture into an extruder, and extruding the extrusion mixture to acetylate the poly Saccharide and form an extrudate comprising the poly Saccharide acetate.

This method is a heterogeneous REX based process, without full dissolution of cellulose, which leads only partial surface functionalisation of cellulose. Non-biobased acylation agents are used and their chain length can not provide intrinsic plasticisation of the product.

7. Reactive Extrusion Process for the Preparation of a High Concentration Solution of Cellulose in Ionic Liquid for In Situ Chemical Modification. RSC Advances, 2013, 3, 1021. DOI: 10.1039/c2ra22296e

Cellulose, [Bmim]Cl, and succinicanhydride were mixed in different ratios in a high-speed universal grinder (25000 rpm for 10 s). The mixtures were then extruded by a twin screw extruder, (EUROLAB-16 XL, with a diameter of 16 mm and a length/ratio of 40/1), under a constant rate of feeding. The reaction time was roughly 2-3 min, in air. The screw speed, temperature and the feeding rate were configured to adapt the reaction time. The temperature of the heating zones was set between 110-140° C. The extruded materials were precipitated in water to remove [Bmim]Cl, filtered, and then extracted using acetone at 65° C. for 16 h to remove the unreacted succinic anhydride and the by-products. Lastly, drying was done at 50° C. for 24 h in a vacuum oven.

This describes another REX based homogeneous acylation of cellulose using the first generation IL-s with limited recycling capacities. Non-biobased acylation agents are used and their chain length can not provide intrinsic plasticisation of the product.

8. Method for Making a Cellulose or Starch Fatty Ester by Esterification or Transesterification. WO2000050493A1

A method for making a cellulose or starch fatty ester by esterification or transesterification of a cellulosic or starchy material using a fatty reagent was disclosed. Describes usage of plant oils or oil based esters for cellulose acylation, characterised in that it consists in introducing the cellulosic or starchy material in solid or fragmented state, the fatty reagent and an esterification or transesterification catalyst in a double-screw device (1) at a temperature ranging between 180° C. and 230° C. so as to subject the reactive mixture to a thermomechanical treatment during the reaction; drawing the resulting pasty mixture and isolating the cellulose or starch fatty ester by solvent extraction from the other constituents of the pasty mixture. The method enables to make a cellulosic or starchy material hydrophobic without using toxic solvents.

The document describes heterogeneous REX based process with added catalyst, without full dissolution of cellulose, which leads only partial functionalisation of cellulose. Although, plant based oils are mentioned for transesterification, the described reaction is efficient only at high temperatures, above 180° C. Continuous process for collecting and cleaning of the cellulose derivative is needed.

### DISCLOSURE OF INVENTION

The goal of the invention is achieved by applying methods developed for processing highly viscous liquids such as polymer melts in extruders or compounders, known in the plastics industry. High shear forces are applied to ensure mixing in such devices. Mechanochemical action accelerates the acylation reaction. Reactive extrusion (REX) or compounding reduces the need of solvents and accelerate the chemical processes or facilitate processes, which have low reactivity in milder conditions as acylation with plant oils, triglycerides or esters of biobased fatty acids.

The invention further provides a continuous process for collecting and cleaning of the acylated product using underwater pelletizer and recycling the ionic liquid used for dissolution and as the reaction environment.

The goal of the invention is achieved with a reactive extrusion line for manufacturing thermoplastics from cellulose, said line comprising a premixing tank with a motor for mixing a solvent and said cellulose into a slurry, a compounder for receiving said slurry, an underwater pelletizer driven by a motor and connected to an output of said compounder, a solid separation unit with input connected to the output of said underwater pelletizer, a washing unit connected to the output of said solid separation unit and drying unit connected to the output of said washing unit.

The goal of the invention is also achieved with a method for manufacturing thermoplastic material from cellulose in a continuous process, comprising:
mechanically pre-mixing a cellulose, a solvent and a functionalisation agent into a slurry, wherein said solvent is an ioniq liquid, selected from a group, where a cation of said ionic liquid is onium or imidasolium based and anion of said ionic liquid is a halide, and said functionalisation agent is selected from a group consisting of a fatty acid, fatty acid ester, fatty acid vinyl ester, fatty acid anhydride, fatty acid halide;
completing functionalisation of said slurry in a compounder;
forming a product from said compounder into flakes and removing solvent from said flakes in an underwater pelletizer;
separating flakes from water and solvent by a sieve;
washing the flakes; and
drying said flakes into a solid cellulose derivative.

### BRIEF DESCRIPTION OF DRAWINGS

FIG. 1 is a schematics of reactive extrusion line of cellulose according to one embodiment of the invention.

FIG. 2 is an FTIR spectra of CL samples obtained at different DMSO to IL ratios by reactive extrusion, where: MCC, No co-solvent (only IL), 1:1 DMSO:IL, 2:1 DMSO:IL, 3:1 DMSO:IL.

FIG. 3 is a statistical analysis of peak ratios.

FIG. 4 is an FTIR spectra of CL samples obtained at different DMSO to IL ratios by reactive extrusion, where: MCC, 10% of catalyst, No catalyst.

FIG. 5. Statistical analysis of peak ratios of FTIR spectra of CL samples obtained by reactive extrusion from mixtures with and without catalyst.

FIG. 6. FTIR spectra of CL samples obtained by reactive extrusion from mixtures with addition of co-solvent. MCC, VL, DMSO and IL were first mixed mechanically and pre-treated before reactive extrusion: MCC, 4 h 80° C., 12 h 60° C., 20 h 40° C., 1 week RT.

FIG. 7. Statistical analysis of peak ratios of FTIR spectra of CL samples obtained by reactive extrusion from mixtures, pre-treated at different conditions named in Table 1.

FIG. 8. FTIR spectra of CL samples obtained by reactive extrusion from mixtures, which were subject to ultrasonic treatment before extrusion at different temperatures for different times.

FIG. 9. Statistical analysis of FTIR spectra of CL samples obtained by reactive extrusion from mixtures, pre-treated at different temperatures (40-80° C.) times (30 min-1 h).

FIG. 10. FTIR spectra of CL samples obtained at different temperatures by reactive extrusion: MCC, CL10_100_60_11, CL10_120_60_11, CL_10_130_60_11.

FIG. 11. Statistical analysis of FTIR spectra of CL samples obtained by reactive extrusion conducted at different temperatures.

FIG. 12. Overlaid spectra of cellulose-vinyl laurate (CL-VL) samples with different washing procedures. ′ä

FIG. 13. Overlaid spectra of cellulose-rapeseed oil (CL-SO) samples with different washing procedures

### EXAMPLES FOR CARRYING OUT THE INVENTION

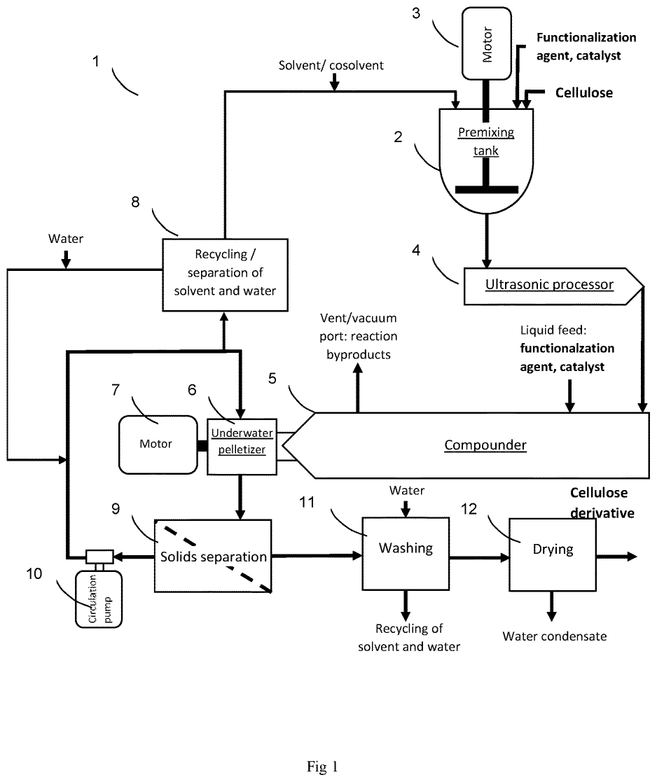

FIG. 1 is a schematics of reactive extrusion line 1 of cellulose according to the invention, comprising a premixing tank 2 with a motor 3 for mixing solvent, co-solvent and cellulose, preferably in the presence of appropriate catalyst and functionalization agent. A cellulose slurry is then transferred into an ultrasonic processor 4 and then into a compounder 5 where also liquid feed of functionalization agent and catalyst is introduced and reaction byproducts are extracted. An output from the compounder is transferred into an underwater pelletizer 6, driven by motor 7. The product is transferred to a solid separation unit 9, where solvent residues containing water is pumped by pump 10 to recycling/separation of solvent and water unit 8 and the water recycled back to the system. The output of solids separation unit 9 is a solvent containing cellulose derivative. It is sent to the washing unit 11 for separating solvent and the cellulose derivative; solvent and water are recycled. Then the cellulose derivative is dried in a drying unit 12, thereby producing a cellulose derivative.

### Description of the Method

The goal of the invention is also achieved with a method for manufacturing thermoplastic material from cellulose in a continuous process, comprising mechanically pre-mixing a cellulose, a solvent and a functionalisation agent into a slurry, wherein said solvent is an ioniq liquid, selected from a group, where a cation of said ionic liquid is onium or imidasolium based and anion of said ionic liquid is a halide, and said functionalisation agent is selected from a group consisting of a fatty acid, fatty acid ester, fatty acid vinyl ester, fatty acid anhydride, fatty acid halide; completing functionalisation of said slurry in a compounder; forming a product from said compounder into flakes and removing solvent from said flakes in an underwater pelletizer; separating flakes from water and solvent by a sieve;
washing the flakes; and drying said flakes into a solid cellulose derivative.

The method according to the invention comprises the following. The process uses cellulose, solvents, functionalisation agents, co-solvents and catalyst.

Preferably, the cellulose is dissolving pulp or microcrystalline cellulose. However, cellulose containing textile fibres or their production byproducts, as for example primary or recycled cotton fibres, cotton linter, other cellulosic, primary or recycled textile fibres can be used.

The solvent is an ionic liquid. The solvent should withstand the processing temperature, hydrolysis and should be recyclable by distillation. Cation of the ionic liquid can be onium or imidasolium based, more preferably originating from amidiene and guanidiene type superbase, which may have open chain or bicyclic structure. The anion of the ionic liquid must have strong hydrogen-bond basicity for efficient dissolution of cellulose. The anion can be a halide, but most preferably originating from carboxylic acids as acetates or propionates.

The co-solvent is for controlling the viscosity of the processing mixture. In addition, co-solvent supports dissolution power of the ionic liquid by making its anions stronger nucleophiles by solvating cations of the ionic liquid. Therefore, polar, aprotic co-solvents are preferred. The co-solvent should withstand the processing conditions, should be recyclable and of low toxicity. The most common co-solvent for such purpose is Dimethyl Sulfoxide (DMSO). However, bio-based co-solvents such as Cyrene, Dimethyl Isosorbide (DMI), Dimethyl Propylene Urea (DMPU) or Sulfolane are preferred.

The functionalisation agent reacts with primary and/or secondary hydroxyl groups of the cellulose anhydroglucose unit (esterification) forming ester functional groups with alkyl (fatty acid) chain length 6-22 carbons, preferable 12-18 carbons. The functional groups disrupt intra- and intermolecular hydrogen bonding of cellulose macromolecules and act as internal plasticizers making the material thermoplastic and processable by regular plastic processing technology, preferably extrusion and injection molding. The functionalisation agent can be a fatty acid, fatty acid ester, fatty acid vinyl ester, fatty acid anhydride, fatty acid halide, more preferable bio-based triglyceride (plant or bacterial oil), fatty acid or fatty acid ester originating from such triglyceride.

In minor amount, the catalyst accelerates the esterification reaction. Suitable catalysts are, for example inorganic acids, lipases, oil-shale ashes, more preferably abovementioned superbases as components of abovementioned ionic liquids taken in excess. Amount of the catalyst is preferably up to 10 wt % of the solvent (together with cosolvent, if also co-solvent is used).

Cellulose, solvent and functionalisation agent (together with a cosolvent and a catalyst) are mixed in a premixing tank for partial dissolving, swelling and preliminary esterification of the cellulose. Preferably, the pre-mixing is conducted for 2-6 h at 40-80° C., more preferably for about 4 h at about 80° C.

Preferably, an ultrasonic treatment is applied to the mixture after premixing and before transferring it to the compounder for increasing solubility of cellulose in the ionic liquids and accelerating the functionalisation reaction. The treatment can be carried out in a batch or preferably, in a continuous flow through a sonification system between the premixing tank and the compounder.

The slurry is transferred to the compounder and the functionalisation reaction is completed at 80-130° C. for 3-10 min, preferably at 120° C. for 3 to 5 min. Preferably, an additional amount of functionalisation agent and/or catalyst is added by a liquid feed port of the compounder. Volatile reaction byproducts are removed from a vacuum port of the compounder for driving the reaction balance towards formation of the product.

The product is extruded to the underwater pelletizer, where thin flakes are formed and precipitated in a circulating water stream. The circulating water dissolves and removes majority of the solvent, co-solvent, catalyst and reaction byproducts from the flakes.

Flakes and water/solvent mixture is separated by a sieve. The flakes can be milled into powder form for more efficient removal of the residues. The solid product is additionally/soaked and washed e.g., in ethanol, preferable in water for 0.5-4 h, preferably for 1 h at room temperature (about 20-25° C.) for removing excess of the residues. The solid product is separated from the soaking liquid by sieving and/or centrifugation. The solid cellulose derivative is dried in oven at 50-80° C., preferably at 60° C., for 4-24 h, preferable for 6 h. Vacuum is applied for accelerating the drying process. Water/solvent/co-solvent mixture is separated and reused when certain solvent concentration is achieved in the precipitation and washing/soaking liquids.

### Effect of Co-Solvent to Ionic Liquid Ratio

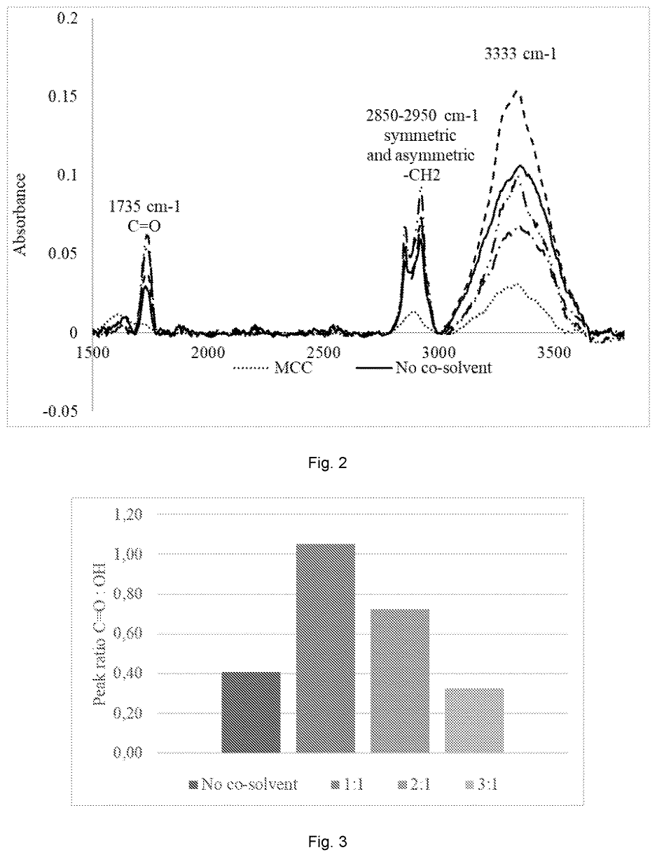

FIG. 2 demonstrates the effect of different ratio of DMSO to IL on the efficiency of acylation reaction in reactive extrusion. It is evident, that addition of DMSO have positive effect on the efficiency of esterification reaction. Signal for 1 to 1 ratio is clearer and more intensive compared to sample in which only IL was used as a solvent. Observed FTIR spectra peaks at 2921 and 2855 wavenumbers are even more separate for sample with increased DMSO to IL ratio up to 2 to 1. However further increase of DMSO and decrease of IL content is leading to opposite result and at 3 to 1 ratio decrease of the intensity. Analysis of C═O to OH peaks ratio showed that best result was achieved at 1:1 ratio of DMSO:IL. FIG. 3 is a statistical analysis of peak ratios.

### Effect of Addition of Superbase as a Catalyst

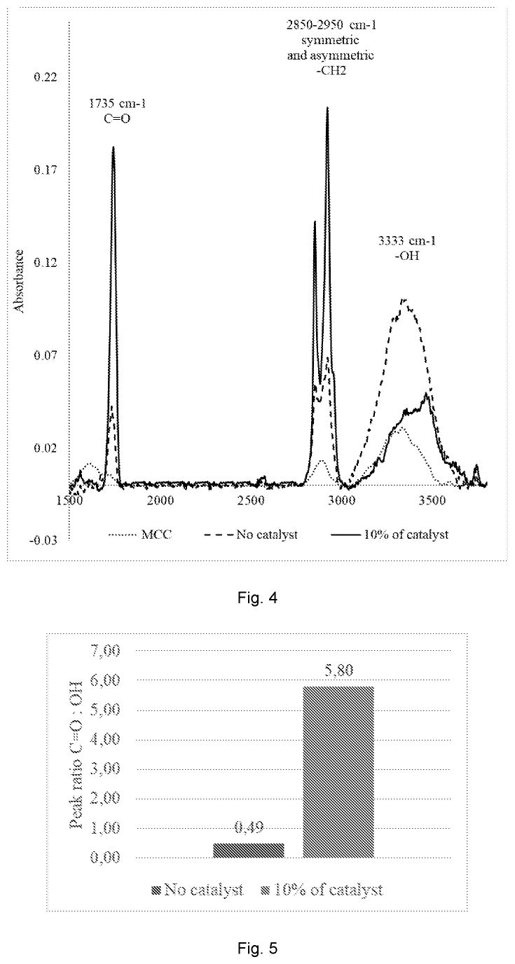

FIG. 4 demonstrates the effect of addition of superbase as a catalyst. 10% of the total amount of IL was added before pre-treatment and it had very positive effect. —OH peak intensity decreased a lot and C═O peak near 1740 cm⁻¹ significantly increased, statistical analysis confirms efficiency of catalyst addition.

### Effect of Pre-Treatment Temperature and Duration

Samples of MCC, VL, DMSO and IL were pre-treated (mixed mechanically and after that stored in the oven) at different temperatures for different times as follows:

TABLE 1
Pre-treatment conditions

| | |
|---|---|
| Pre-treatment time | Pre-treatment temperature (° C.) |

| | | |
|---|---|---|
| 1 | week | RT |
| 20 | h | 40 |
| 12 | h | 60 |
| 4 | h | 80 |

The highest ratio of C═O to —OH peak was achieved during storage of mixture for 1 week at RT. However, it is not reasonable in production. Other results showed that application of higher temperature and shorter time is beneficial. Storage of the pre-mixed samples at 80C for 4 h before extrusion process showed the best result.

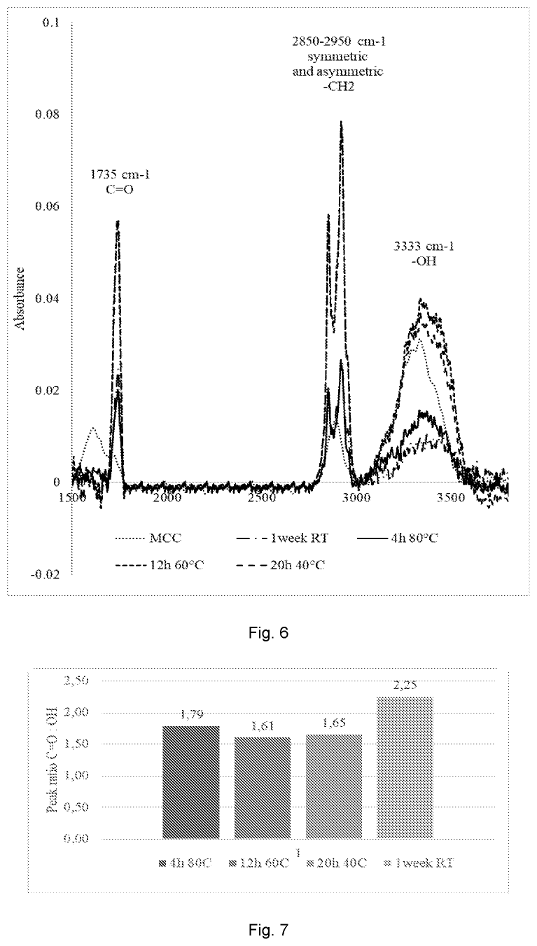

FIG. 5. Statistical analysis of peak ratios of FTIR spectra of CL samples obtained by reactive extrusion from mixtures with and without catalyst. FIG. 6. FTIR spectra of CL samples obtained by reactive extrusion from mixtures with addition of co-solvent. MCC, VL, DMSO and IL were first mixed mechanically and pre-treated before reactive extrusion: MCC, 4 h 80° C., 12 h 60° C., 20 h 40° C., 1 week RT. FIG. 7. Statistical analysis of peak ratios of FTIR spectra of CL samples obtained by reactive extrusion from mixtures, pre-treated at different conditions named in Table 1.

### Effect of Ultrasonication Parameters

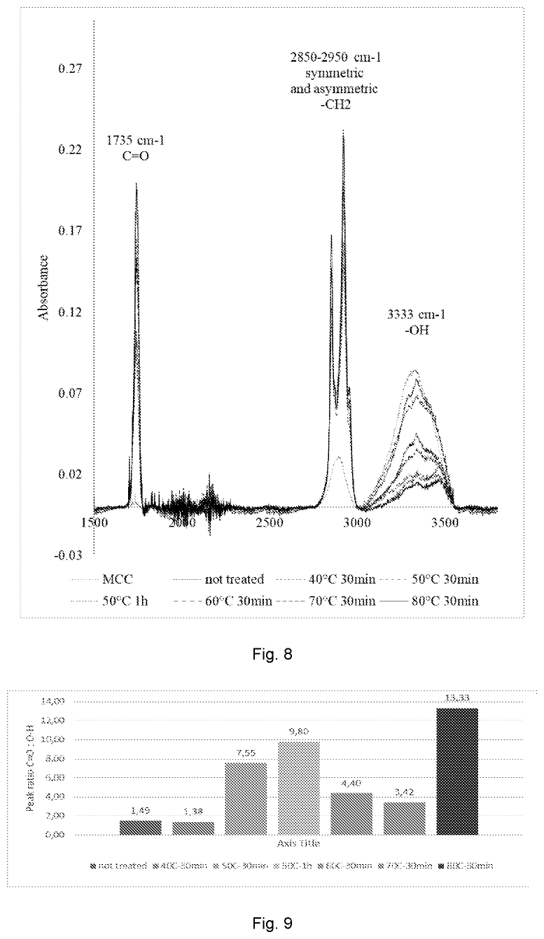

Seven samples were prepared and treated at different temperatures under ultrasonic treatment for 30 minutes and 1 hour. FIG. 8 represents FTIR spectra and FIG. 9 statistical analysis of the ratio of C═O peak at around 1740 cm⁻¹ to decreased —OH peak at around 3330 cm⁻¹

US treatment at 80C for 30 min was found to be the optimal for mixtures, containing 10% of catalyst.

### Effect of Reactive Extrusion Temperature

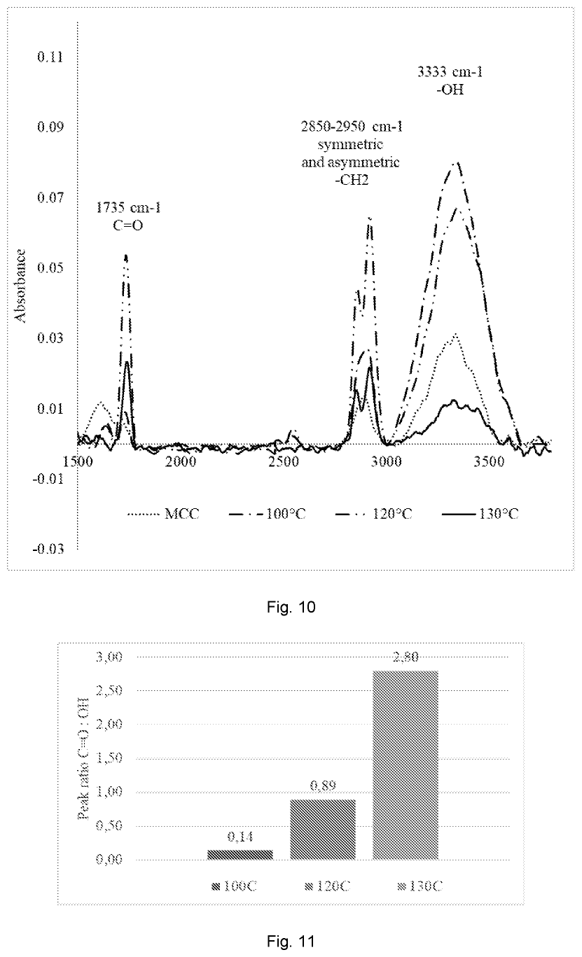

FIG. 10 represent spectra of CL samples prepared by reactive extrusion at different temperatures in a compounder. 100° C. is not an efficient temperature for the quick reaction in compounder. C═O stretching of the ester group in 1730-1740 cm⁻¹ region is inconspicuous and no separate peaks of symmetric and asymmetric —CH₂ in 2850-2950 cm⁻¹ region is present. With increase of the temperature of reactive extrusion process up to 120° C. the significant increase of peaks intensity and separation of the symmetric (2920 cm⁻¹) and asymmetric (2858 cm⁻¹) peaks of —CH₂ stretching was observed. Statistical analysis of C═O to —OH peaks ration showed, that extrusion at 130° C. shows the best acylation result. However, at this temperature of the reactive extrusion a drastical effect on the ionic liquid was observed. At temperatures of above 120 it started to decompose quickly and it was not possible to restore it any more from CL samples. The optimised temperature for reactive extrusion was chosen as 120° C. FIG. 11. Statistical analysis of FTIR spectra of CL samples obtained by reactive extrusion conducted at different temperatures.

### Effect of Water Washing Procedures

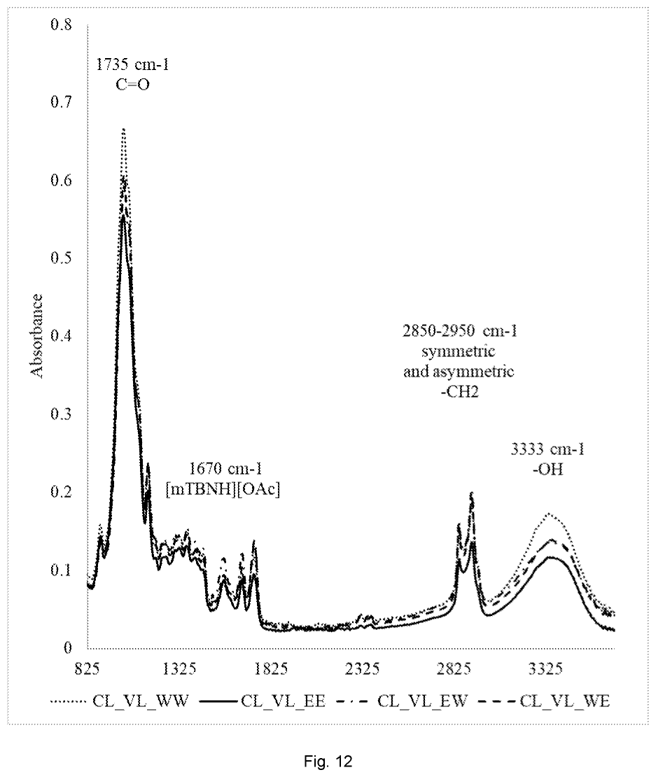

Cellulose ester samples were made using vinyl laurate (VL) or rapeseed oil (SO) as esterification agents. FIG. 12 shows the overlaid spectra of CL-VL esters with different washing combinations. To better compare the different washing procedures, the ratio of the esterification peak absorbance at 1736 cm−1 to the ionic liquid peak absorbance at 1670 cm−1 was calculated (Table 2). This was to identify which washing procedure is more effective in removing the residual ionic liquid in the sample. Water-Ethanol (WE) and Water-Water (WW) were found to be the most effective washing procedures. However, for WW, the O—H band at 3360 cm−1 is more intense than the rest and this may be attributed to the residual moisture in the sample as the drying was only done at 70° C.

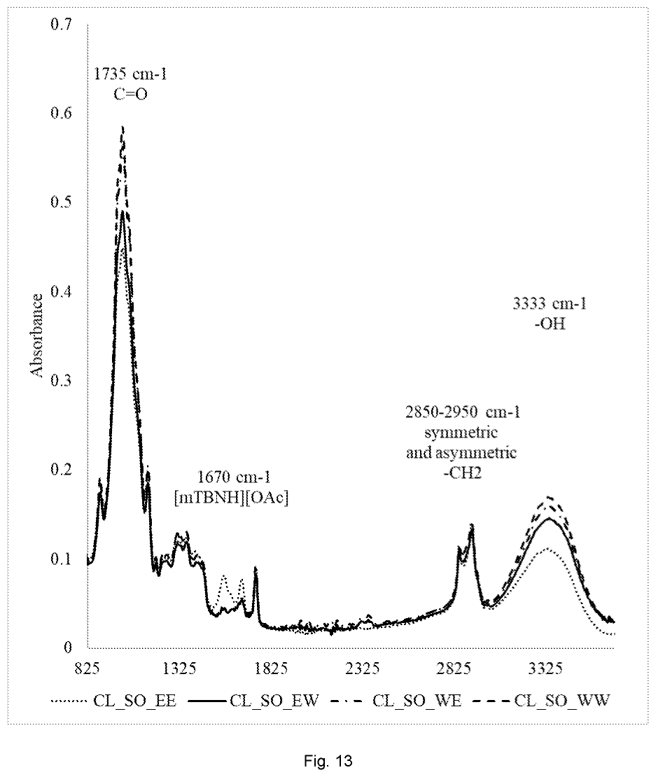

On the other hand, FIG. 13 shows the effect of different washing procedures for CL-SO samples. For this, the ratio of the absorbances at 1744 cm−1 to 1670 cm−1 were calculated (Table 3). The most effective washing method was WE, followed by EW, then by WW, and with EE being the poorest method to remove residual ionic liquid.

TABLE 2
Calculation of the ratio of the esterification peak
absorbance at 1736 cm−1 to [mTBNH][OAc]
peak at 1670 cm−1 for CL-VL samples.

| Sample | Abs₁₇₃₆ | Abs₁₆₇₀ | Abs₁₇₃₆/Abs₁₆₇₀ |
|---|---|---|---|
| CL_VL_WW | 0.031 | 0.031 | 2.19 |
| CL_VL_EW | 0.058 | 0.088 | 1.52 |
| CL_VL_WE | 0.04 | 0.088 | 2.20 |
| CL_VL_EE | 0.037 | 0.058 | 1.57 |

TABLE 3
Calculation of the ratio of the esterification peak
absorbance at 1744 cm−1 to [mTBNH][OAc]
peak at 1670 cm−1 for CL-SO samples.

| Sample | Abs₁₇₄₄ | Abs₁₆₇₀ | Abs₁₇₄₄/Abs₁₆₇₀ |
|---|---|---|---|
| CL_SO_WW | 0.016 | 0.048 | 3.00 |
| CL_SO_EW | 0.013 | 0.053 | 4.08 |
| CL_SO_WE | 0.011 | 0.062 | 5.64 |
| CL_SO_EE | 0.035 | 0.061 | 1.74 |

1. A reactive extrusion line for manufacturing thermoplastics from cellulose, said line comprising: a pre-mixing tank with a motor for mixing a solvent and said cellulose into a slurry, a compounder for receiving said slurry, an underwater pelletizer driven by a motor and connected to an output of said compounder, a solid separation unit with input connected to the output of said underwater pelletizer, a washing unit connected to the output of said solid separation unit and a drying unit connected to the output of said washing unit.

2. A method for manufacturing thermoplastic material from cellulose in a continuous process, the method comprising:
mechanically pre-mixing a cellulose, a solvent and a functionalisation agent into a slurry in a pre-mixing tank; wherein said solvent is an ionic liquid, wherein a cation of said ionic liquid is onium or imidazolium-based, and wherein an anion of said ionic liquid is a halide; and wherein said functionalisation agent is selected from a group consisting of a fatty acid, a fatty acid ester, a fatty acid vinyl ester, a fatty acid anhydride, and a fatty acid halide;
completing functionalisation of said slurry in a compounder;
forming a product from said compounder into flakes and removing solvent from said flakes in an underwater pelletizer;
separating flakes from water and solvent by a sieve;
washing the flakes; and
drying said flakes into a solid cellulose derivative.

3. The method according to claim 2, wherein a cosolvent, such as a polar aprotic solvent, selected from a group consisting of Dimethyl Sulfoxide (DMSO), Cyrene, Dimethyl Isosorbide (DMI), Dimethyl Propylene Urea (DMPU) and Sulfolane, is added for controlling viscosity of the slurry and supporting dissolution agent.

4. The method according to claim 2, wherein said functionalisation agent is a bio-based triglyceride, or a fatty acid or fatty acid ester originating from a bio-based triglyceride with a fatty acid chain length of 6 to 22 carbons.

5. The method according to claim 2, further comprising a step of ultrasonic treatment of said slurry before transferring it from said pre-mixing tank into said compounder for accelerating the functionalisation reaction.

6. The method according to claim 5, wherein said ultrasonic treatment is carried out in a continuous flow from said pre-mixing tank to said compounder.

7. The method according to claim 5, wherein said ultrasonic treatment is carried out in a batch.

8. The method according to claim 2, wherein a catalyst for accelerating the esterification reaction is added, and wherein said catalyst is an organic superbase.

9. The method according to claim 8, wherein said catalyst is selected from a group consisting of inorganic acids, lipases, and oil-shale ashes.

10. The method according to claim 8, wherein an amount of the catalyst is up to 10 wt % of the solvent and the cosolvent.

11. The method according to claim 2, wherein volatile reaction byproducts are removed from said compounder for driving a reaction balance towards formation of the product.

12. The method according to claim 2, wherein said pre-mixing is conducted for 2 to 6 hours at 40 to 80° C.

13. The method according to claim 12, wherein said pre-mixing is conducted for 4 hours at 60° C.

14. The method according to claim 2, wherein said functionalisation is completed in said compounder at 80 to 130° C. for 3 to 10 min.

15. The method according to claim 14, wherein said functionalisation is completed in said compounder at 100° C. for 3 to 5 min

16. The method according to claim 2, wherein said washing is carried out in water for 0.5 to 4 hours, preferably for 1 h at room temperature.

17. The method according to claim 2, wherein said drying is carried out at 50 to 80° C. for 4 to 24 hours, preferably for 6 hours.
